(19) United States
(12) Patent Application Publication
(10) Pub. No.: US 2026/0111235 A1
(43) Pub. Date: Apr. 23, 2026

(54) COMPUTING SYSTEM, MODEL TRAINING METHOD AND APPARATUS, AND PRODUCT

(71) Applicant: SUZHOU METABRAIN INTELLIGENT TECHNOLOGY CO., LTD., Suzhou, Jiangsu (CN)

(72) Inventor: Zheng ZHANG, Suzhou, Jiangsu (CN)

(21) Appl. No.: 19/116,181

(22) PCT Filed: Feb. 28, 2024
(86) PCT No.: PCT/CN2024/078899

§ 371 Date: Mar. 27, 2025

(30) Foreign Application Priority Data
Jun. 27, 2023 (CN) 202310770034.8

(51) Int. Cl. G06F 9/38; G06F 13/42

(52) U.S. Cl. CPC G06F 9/3888; G06F 13/4282; G06F 2213/0026

(57) ABSTRACT

The present application relates to a computing system, a model training method and apparatus, and a product. The computing system relates to a computing unit, and the computing unit comprises: a main board, which is configured with a central processing unit (CPU); and a base board, which is connected to the main board by means of a first communication link, wherein the base board is configured with a plurality of accelerator cards, and the plurality of accelerator cards are connected to each other by means of a second communication link. The main board is used for splitting a training task of a target model into a plurality of concurrent model training tasks and releasing same to the plurality of accelerator cards, and processing training results of the plurality of accelerator cards, so as to obtain a trained target model. The plurality of accelerator cards are used for concurrently executing the respective model training tasks thereof, so as to obtain the training results. The computing system forms an elastically scalable computing system architecture by means of modular base-board design and interconnection, such that the computing power and bandwidth of the computing system can match model training tasks at different parameter scales.

### CROSS-REFERENCE TO RELATED APPLICATION

The present application claims priority to Chinese patent application No. 202310770034.8, entitled “COMPUTING SYSTEM, MODEL TRAINING METHOD AND APPARATUS, AND PRODUCT”, filed on Jun. 27, 2023 before the China National Intellectual Property Administration, which is incorporated herein in its entirety by reference.

### TECHNICAL FIELD

The present application relates to the field of computers, and in particular, to a computing system, a model training method, a device, and a product.

### BACKGROUND

With the rapid development of Artificial Intelligence (AI), the AI has now entered the era of large models. AI large models are deep neural networks composed of a vast number of layers and parameters, which can be understood as deep neural networks consisting of tens of millions or even hundreds of millions of layers and parameters. Due to their massive number of layers and parameters, AI large models have achieved significant leaps in precision and performance.

AI large models have demonstrated remarkable improvements in prediction accuracy for tasks such as computer vision, speech recognition, and natural language processing. Among the various domains, natural language processing is currently the most active and focused area in the development of AI large models.

### SUMMARY

In view of the above, the present application aims to propose a computing system, a model training method, a device, and a product.

To achieve the above objectives, technical solutions of this application are as follows:

A first aspect of embodiments of this application provides a computing unit, including a mainboard equipped with a Central Processing Unit (CPU); and a baseboard connected to the mainboard via a first communication link, where the baseboard is equipped with a plurality of accelerator cards that are connected via a second communication link. The mainboard is configured to split a training task of a target model into a plurality of parallel model training tasks, distribute the plurality of parallel model training tasks to the plurality of accelerator cards, and process training results from the plurality of accelerator cards to obtain a trained target model. The plurality of accelerator cards are configured to execute their respective model training tasks in parallel and generate the training results.

In some embodiments, every two accelerator cards among the plurality of accelerator cards are connected via one second communication link.

In some embodiments, the mainboard and the baseboard are connected via the first communication link.

In some embodiments, a ratio of a number of the CPU to a number of the plurality of accelerator cards is 1:4.

A second aspect of embodiments of this application provides a computing node, including a first computing unit and a second computing unit, and both the first computing unit and the second computing unit are the computing unit described in the first aspect.

In some embodiments, the CPU on the mainboard of the first computing unit is connected to the CPU on the mainboard of the second computing unit via a third communication link.

In some embodiments, the computing node further includes a switch expansion board configured to connect the first computing unit with the second computing unit.

In some embodiments, the switch expansion board is equipped with two switch chips; the accelerator cards in the first computing unit and the second computing unit are each connected to each of the two switch chips via a fourth communication link.

In some embodiments, each of the switch chips on the switch expansion board is equipped with a horizontal expansion interface, and the horizontal expansion interface is configured to be connected to switch chips on switch expansion boards in other computing nodes.

In some embodiments, each of the switch chips is a PCIe chip, and the fourth communication link is a PCIe communication link.

A third aspect of embodiments of this application provides a computing system, including a first computing node and a second computing node, and both the first computing node and the second computing node are the computing node described in the second aspect.

In some embodiments, the horizontal expansion interface of the first switch chip on the switch expansion board of the first computing node is connected to the horizontal expansion interface of the second switch chip on the switch expansion board of the second computing node via one fifth communication link; and the horizontal expansion interface of the second switch chip on the switch expansion board of the first computing node is connected to the horizontal expansion interface of the first switch chip on the switch expansion board of the second computing node via one fifth communication link.

A fourth aspect of embodiments of this application provides a computing system, including at least three computing nodes, and each of the computing nodes is the computing node described in the second aspect.

In some embodiments, for each computing node among the at least three computing nodes, the horizontal expansion interfaces of the two switch chips on the switch expansion board in the computing node are each connected to the horizontal expansion interfaces of the switch chips on the switch expansion boards in two different computing nodes among the at least three computing nodes via one fifth communication link.

A fifth aspect of embodiments of this application provides a model training method, including:
determining a parameter quantity of a target model;
determining a target computing system required for use based on the parameter quantity of the target model; and
executing training tasks of the target model by using the target computing system, and obtaining a trained target model.

In some embodiments, the determining a target computing system required for use based on the parameter quantity of the target model includes:
determining a target interval in which the parameter quantity of the target model is located from multiple intervals;
in response to determining that the target interval is a first interval, determining that the target computing system required for use is the computing unit described in the first aspect;
in response to determining that the target interval is a second interval, determining that the target computing system required for use is the computing node described in the second aspect, wherein an upper limit of the first interval is less than a lower limit of the second interval;
in response to determining that the target interval is a third interval, determining that the target computing system required for use is the computing system described in the third aspect, wherein an upper limit of the second interval is less than a lower limit of the third interval;
in response to determining that the target interval is a fourth interval, determining that the target computing system required for use is the computing system described in the fourth aspect, wherein an upper limit of the third interval is less than a lower limit of the fourth interval.

In some embodiments, the determining a parameter quantity of a target model includes:
determining the parameter quantity of at least one model to be trained, wherein the at least one model to be trained is a model supporting parallel computation, and the at least one model to be trained comprises a Transformer model.

A sixth aspect of the embodiment of this application provides a model training apparatus, including:
a first determination module, configured to determine a parameter quantity of a target model;
a second determination module, configured to determine a target computing system required for use based on the parameter quantity of the target model; and
an execution module, configured to utilize the target computing system to execute training tasks of the target model and obtain a trained target model.

A seventh aspect of the embodiment of this application provides a non-volatile computer readable storage medium storing with a computer program that, when executed by a processor, causes the processor to implement steps in the model training method described in the fifth aspect.

An eighth aspect of the embodiment of this application provides an electronic device, including a memory, a processor, and a computer program stored on the memory and executable on the processor, wherein, when the processor executes the computer program, steps in the model training method described in the fifth aspect are implemented.

### BRIEF DESCRIPTION OF THE DRAWINGS

In order to describe the technical solutions in the application more clearly, the accompanying drawings required for describing embodiments will be briefly introduced below. Apparently, the drawings in the following description are only some embodiments of the present application. For those skilled in the art, other drawings can be obtained based on these drawings without creative effort.

FIG. 1 is a schematic architecture diagram of a computing unit provided in an embodiment of the present application;

FIG. 2 is a schematic architecture diagram of a computing node provided in an embodiment of the present application;

FIG. 3 is a schematic architecture diagram of a computing system provided in an embodiment of the present application;

FIG. 4 is a schematic architecture diagram of a computing system provided in an embodiment of the present application;

FIG. 5 is a flowchart of a model training method provided in an embodiment of the present application;

FIG. 6 is a schematic diagram of a model training device provided in an embodiment of the present application; and

FIG. 7 is a schematic diagram of an electronic device provided in an embodiment of the present application.

### DETAILED DESCRIPTION OF THE EMBODIMENTS

The technical solutions in the embodiments of the present application will be described clearly and completely below in conjunction with the accompanying drawings in the embodiments of the present application. Apparently, the described embodiments are only a part of the embodiments of the present application, rather than all of them. Based on the embodiments of the present application, all other embodiments obtained by those of skilled in the art without creative efforts shall fall within the scope of protection of the present application.

It should be understood that the term “an embodiment” or “one embodiment” mentioned throughout the specification means that a specific feature, structure, or characteristic related to the embodiment is included in at least one embodiment of the present application. Therefore, the phrases “in one embodiment” or “in an embodiment” appearing in various places in the specification do not necessarily refer to the same embodiment. In addition, these specific features, structures, or characteristics may be combined in any suitable manner in one or more embodiments.

In the various embodiments of the present application, it should be understood that the size of the sequence numbers of the following processes does not imply the order of execution. The execution order of each process should be determined by its function and internal logic, and should not impose any limitation on the implementation process of the embodiments of the present application.

Here, exemplary embodiments will be described in detail, with examples illustrated in the accompanying drawings. When the following description refers to the drawings, unless otherwise indicated, the same numbers in different drawings represent the same or similar elements. The implementation methods described in the following exemplary embodiments do not represent all implementations consistent with the present application. On the contrary, they are merely examples of devices and methods consistent with some aspects of the present application as detailed in the appended claims.

It should be noted that, in the absence of conflict, the embodiments in the present application and the features in the embodiments may be combined with each other.

The present application will be described in detail below with reference to the accompanying drawings and in conjunction with the embodiments.

Previously, commonly used neural networks are consisted of a few hundred to a few thousand parameters. However, the execution efficiency and prediction accuracy of these smaller neural networks were limited. AI large models refer to vast and complex neural networks that require storing more parameters to increase the depth and breadth of the models, thereby enhancing performance capabilities of the models. These models typically start with tens of billions of parameters, massive datasets are trained to obtain high-quality predictions. Some AI large models even reach the scale of hundreds of billions of parameters. As models grow larger, their requirements for data filtering, logical complexity, algorithm matching, hardware specifications, and model optimization also increase significantly. Consequently, the difficulty and cost of training these models rise accordingly.

Computational power is a fundamental requirement for building a large model ecosystem. AI large models usually need to be trained on large GPU clusters, necessitating substantial computational resources and data storage resources. For example, the Megatron Turing-NLG, jointly released by Microsoft and NVIDIA, has 530 billion parameters, and the current largest Large Language Models (LLMs) have more than trillions of parameters. The increase in model parameters also imposes higher demands on computational architectures, requiring systems with greater computational power and larger interconnection bandwidths to support parallel training of these models. More parameters mean that more computational resources are needed. AI large models consume enormous computational power during training and inference processes. Therefore, the computational systems used for training these models must possess exceptionally high computational capabilities. Only systems with supercomputing power can support the massive data processing required by AI large models.

Currently, the architectures of computational systems used for training AI large models are highly homogeneous. With the increase in system power consumption and the growing demand for system scalability from larger models, existing system architectures face numerous challenges, including high system complexity and high costs for system expansion.

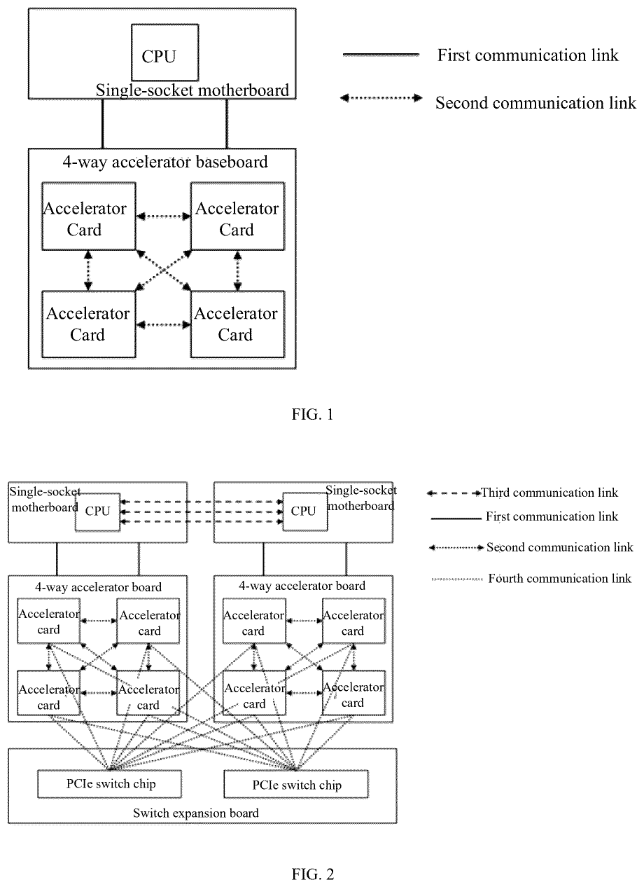

FIG. 1 is a schematic architecture diagram of a computing unit provided in an embodiment of the present application. As shown in FIG. 1, the computing unit includes a mainboard and a baseboard.

The mainboard is equipped with a Central Processing Unit (CPU).

The baseboard is connected to the mainboard via a first communication link, and equipped with a plurality of accelerator cards. The plurality of accelerator cards are connected via a second communication link.

The mainboard is configured to split a training task of a target model into a plurality of parallel model training tasks and distribute them to the plurality of accelerator cards, as well as to process training results from the plurality of accelerator cards to obtain a trained target model.

The plurality of accelerator cards are configured to execute their respective model training tasks in parallel and obtain the training results.

As shown in FIG. 1, in this embodiment, the computing unit includes a single-socket mainboard and an accelerator baseboard. The mainboard is equipped with one CPU, and the accelerator baseboard is equipped with a plurality of accelerator cards. The CPU on the single-socket mainboard splits a training task of a model into a plurality of subtasks and sends them to the plurality of accelerator cards, and data computation for the subtasks is completed on the accelerator cards. The mainboard and the accelerator baseboard are connected via the first communication link, which is used by the CPU for distributing the split training tasks to the accelerator cards and processing computation results of the plurality of accelerator cards, thereby obtaining a trained target model. The data computations in various accelerator cards are in parallel. Once the computation tasks in the accelerator cards are completed, the computation results are aggregated and synchronized in the data link. It is worth noting that the specific aggregation and synchronization method of the computation results depends on the upper-level algorithm and is not limited here.

In this embodiment, the CPU splits and distributes the data processing during model training to the plurality of accelerator cards for parallel computation, forming a distributed computing architecture centered around the plurality of accelerator cards to improve the efficiency of data processing during model training.

In some embodiments, among the plurality of accelerator cards, every two accelerator cards are connected via a second communication link.

As shown in FIG. 1, in one embodiment, the accelerator baseboard of the computing unit includes a plurality of accelerator cards that are connected via a second communication link, that is, in the accelerator baseboard, every two accelerator cards are directly connected via one second communication link. This direct connection between every two accelerator cards is called full interconnection. In the case of full interconnection, any two accelerator cards on the accelerator baseboard can communicate directly with each other, without the need for communication via cross-card forwarding or other intermediary methods. In the case of full interconnection among all the accelerator cards on the accelerator baseboard, communication between any two accelerator cards is the fastest and most efficient. Since there is no need for cross-card communication, no latency is introduced between the accelerator cards. As a result, under full interconnection, the communication efficiency between the accelerator cards is optimized. In this embodiment, the second communication link is an integrated circuit on the accelerator baseboard, which supports a corresponding transmission protocol based on the type of accelerator card. For example, when the accelerator card supports the Ethernet protocol, the integrated circuit on the accelerator baseboard is used for transmitting data based on the Ethernet protocol; when the accelerator card supports the PCIe protocol, the integrated circuit on the accelerator baseboard is used for transmitting data based on the PCIe protocol.

In some embodiments, the mainboard and the baseboard are connected via the first communication link.

In this embodiment, the mainboard and the baseboard are connected via the first communication link. As shown in FIG. 1, the first communication link can be a PCIe link. In this embodiment, the CPU on the mainboard communicates with the plurality of accelerator cards on the accelerator baseboard via the PCIe link. The CPU distributes the split training tasks to the plurality of accelerator cards in the accelerator baseboard via the PCIe link, and processes the data computation results of the plurality of accelerator cards to obtain the trained target model.

In this embodiment, as shown in FIG. 1, the single-socket mainboard and the accelerator baseboard are connected via two PCIe links. When the CPU on the single-socket mainboard splits and distributes the data computation tasks to the plurality of accelerator cards on the accelerator baseboard, one of the PCIe links is selected as a downlink data transmission link for communication with the plurality of accelerator cards. When the data computation tasks on the accelerator cards are completed, the other PCIe link is selected as an uplink data transmission link for communication with the CPU. In this case, uplink data and downlink data can be transmitted simultaneously, further improving the data transmission efficiency of the computing unit.

In one embodiment, one of the PCIe links is selected as the data transmission link. When the CPU on the single-socket mainboard splits and distributes the data computation tasks to the plurality of accelerator cards on the accelerator baseboard, it communicates with the plurality of accelerator cards through this transmission link. When the data computation tasks on the accelerator cards are completed, the CPU communicates with the plurality of accelerator cards through the same transmission link. The other PCIe link is used as a backup data transmission link. When the PCIe link used as the data transmission link fails, the computing unit switches the data transmission link to the backup data transmission link to prevent data loss and improve the stability of the computing unit.

In some embodiments, a ratio of the number of CPUs to the number of accelerator cards is 1:4.

In this embodiment, as shown in FIG. 1, the accelerator baseboard is equipped with four accelerator cards, and every two accelerator cards are directly connected, forming a fully interconnected accelerator card architecture. In this computing unit, one CPU communicates directly with four accelerator cards, controlling them to perform distributed parallel computation for model training data.

In this embodiment, the computing unit is composed of a single-socket mainboard and a multi-accelerator baseboard that are connected via two first communication links, and every two of the plurality of accelerator cards on the accelerator baseboard are directly connected via a second communication link, forming a fully interconnected computing architecture. The CPU on the single-socket mainboard communicates with each accelerator card on the accelerator baseboard via the first communication link, and the accelerator cards communicate directly with each other via the second communication link. This computing unit improves the computation efficiency by splitting the data computation during model training and distributing them to a plurality of accelerator cards for parallel execution.

Based on the same creative concept, an embodiment of the present application provides a computing node. Referring to FIG. 2, FIG. 2 is a schematic architecture diagram of a computing node provided in an embodiment of the present application. As shown in FIG. 2, the computing node includes a first computing unit and a second computing unit. Both of the first computing unit and the second computing unit are any of the computing units described in the above embodiment of the present application.

As shown in FIG. 2, in this embodiment, the computing node includes two single-socket mainboards and two accelerator baseboards. Each single-socket mainboard is equipped with a Central Processing Unit (CPU), and each accelerator baseboard is equipped with a plurality of accelerator cards. The CPU on the single-socket mainboard splits the model training task into a plurality of subtasks and sends them to the plurality of accelerator cards, where data computations of the subtasks are completed. The mainboard and the accelerator baseboard are connected via a first communication link, which is used by the CPU for distributing the split training tasks to the accelerator cards and processing the computation results of the plurality of accelerator cards, thereby obtaining the trained target model. The data computations in various accelerator cards are in parallel. Once the computation tasks in the accelerator cards are completed, the computation results are aggregated and synchronized in the data link.

In this embodiment, the computing node is formed by expanding the computing unit described in the above embodiment. For model training tasks with large parameter scales that cannot be handled by a single computing unit, the computing unit is expanded to form a computing node composed of two computing units, providing suitable computational power and bandwidth for model training with large parameter scales.

In some embodiments, the CPU on the mainboard of the first computing unit is connected to the CPU on the mainboard of the second computing unit via a third communication link.

As shown in FIG. 2, in this embodiment, the CPUs on the two single-socket mainboards are connected via the third communication link. The third communication link directly connects the single-socket mainboards of the two computing units in the computing node, enabling the expansion of the CPUs. Based on the architecture of a single computing unit, the CPU and accelerator cards in the computing unit are doubled, so that the computational performance of the computing unit is horizontally expanded, resulting in a proportional increase in the computational power and bandwidth.

In some embodiments, the computing node further includes a switch expansion board configured to connect the first computing unit with the second computing unit.

In this embodiment, to achieve horizontal expansion of the accelerator baseboard module, a switch expansion board is served as a switching unit for connecting the accelerator cards in the first computing unit with the accelerator cards in the second computing unit. The switch expansion board is equipped with two switch chips, through which communication between the accelerator cards in the first computing unit and the accelerator cards in the second computing unit is achieved.

In some embodiments, the switch expansion board is equipped with two switch chips, and the accelerator cards in each of the first computing unit and the second computing unit are each connected to both of the switch chips via a fourth communication link.

In one embodiment, when the accelerator card is horizontally expanded, each accelerator card in the first computing unit is directly connected to each accelerator card in the second computing unit, forming a fully interconnected connection pattern. In a fully interconnected connection pattern, any two accelerator cards in the accelerator baseboards can communicate directly with the highest efficiency and without delay, thus the computational performance of the computing node is optimized by fully interconnecting all accelerator cards in the two computing units.

Specifically, each accelerator card in the first computing unit and the second computing unit is connected to the two switch chips on the switch expansion board via one fourth communication link. The plurality of accelerator cards on the accelerator baseboard in the first computing unit are interconnected via one second communication link, and the plurality of accelerator cards on the accelerator baseboard in the second computing unit are interconnected via one second communication link.

In this embodiment, communication within the accelerator baseboard is achieved through the second communication link, while communication between accelerator baseboards is achieved through the fourth communication link. Each switch chip on the switch expansion board is directly connected to all accelerator cards in the two computing units, enabling direct communication between any two accelerator cards in the two computing units and achieving optimal computational performance at this scale of the computing system.

In some embodiments, the switch chip is a PCIe chip, and the fourth communication link is a PCIe communication link.

In this embodiment, depending on the type of accelerator cards, communication links supporting different transmission protocols can be used for communication between accelerator cards in the two computing units. In some embodiments, PCIe chips are used as switch chips, and PCIe links are used as communication links between the accelerator cards in the two computing units.

In some embodiments, each switch chip on the switch expansion board is equipped with a horizontal expansion interface that is used for connecting to switch chips on switch expansion boards in other computing nodes.

In one embodiment, the switch expansion board of the computing node can also be used to expand the computing node. Each PCIe switch chip on the switch expansion board is equipped with a downlink scale-out expansion interface. A single computing node can be connected to other computing nodes through the scale-out expansion interface, enabling the expansion of computing nodes to meet the parallel computing and interconnection bandwidth requirements of large models with higher parameter scales.

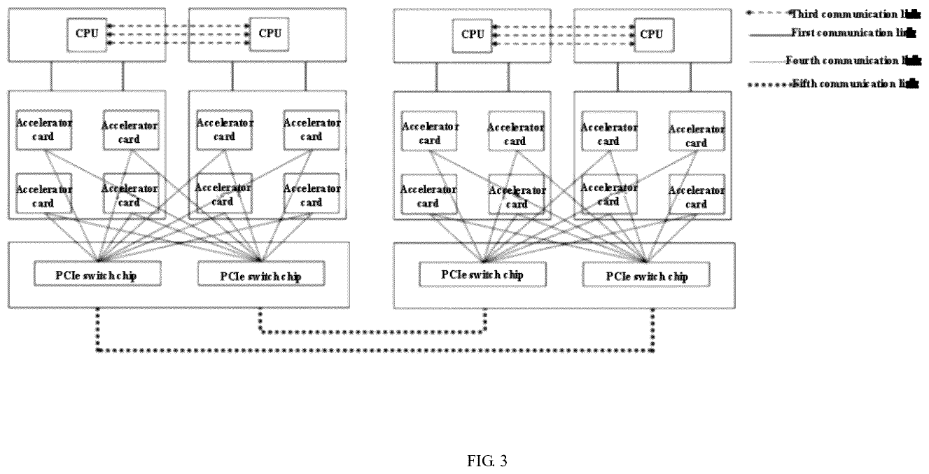

Based on the same creative concept, an embodiment of the present application provides a computing system. Referring to FIG. 3, FIG. 3 is a schematic architecture diagram of a computing system provided in an embodiment of the present application. As shown in FIG. 3, the computing system includes a first computing node and a second computing node that are both computing nodes as described in the second aspect of the present application.

In this embodiment, the computing system includes two computing nodes with identical configurations. Each computing node includes two single-socket mainboards, two accelerator baseboards, and one switch expansion board. In each computing node of this computing system, the CPUs on the two single-socket mainboards are interconnected via the third communication link. Each single-socket mainboard is connected to one accelerator baseboard via the first communication link. Each accelerator card on each accelerator baseboard is connected to two switch chips on the switch expansion board via two fourth communication links. All accelerator cards on each accelerator baseboard are directly interconnected via a second communication link.

The computing system is obtained by horizontally scaling the computing nodes described in the aforementioned embodiments. By horizontally scaling a single computing node, the computational performance of the system is multiplied, thereby meeting the parallel computing and interconnect bandwidth requirements of larger models with higher parameter scales.

In some embodiments, the horizontal expansion interface of the first switch chip on the switch expansion board included in the first computing node is connected to the horizontal expansion interface of the second switch chip on the switch expansion board included in the second computing node via a fifth communication link.

Furthermore, the horizontal expansion interface of the second switch chip on the switch expansion board included in the first computing node is connected to the horizontal expansion interface of the first switch chip on the switch expansion board included in the second computing node via a fifth communication link.

In this embodiment, the horizontal scaling of the computing nodes is achieved through the downlink scale-out expansion interface reserved on the switching expansion boards. As shown in FIG. 3, within the computing system, two computing nodes are interconnected via scale-out expansion interfaces utilizing two fifth communication links. Specifically, the first PCIe switch chip on the switch expansion board of the first computing node is connected to the second PCIe switch chip on the switch expansion board of the second computing node via one fifth communication link; the second PCIe switch chip on the switch expansion board of the first computing node is connected to the first PCIe switch chip on the switch expansion board of the second computing node via another fifth communication link. It should be noted that in this computing system, when two computing nodes are connected via PCIe chips, there are no restrictions on the connection sequence. The connection method described in this embodiment is only used to illustrate the horizontal scaling of computing nodes through the scale-out expansion interfaces reserved on the PCIe chips.

In this computing system, the accelerator cards on the accelerator baseboards of each computing node are not only interconnected within their respective nodes but also connected to the accelerator cards in the other node via the fifth communication links. Thus, all accelerator cards in this computing system form a fully interconnected network, enabling the computing system to achieve optimal computational performance at the current node scale.

For example, the fifth communication link can be a high-density connector, enabling high-speed data transmission while ensuring signal quality.

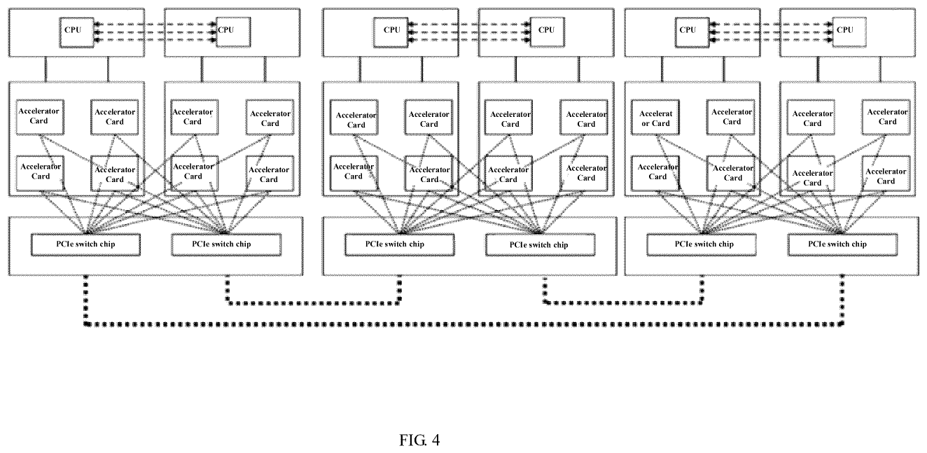

Based on the same creative concept, an embodiment of the present application provides a computing system. Referring to FIG. 4, FIG. 4 is a schematic architecture diagram of a computing system provided in an embodiment of the present application. As shown in FIG. 4, the computing system includes at least three computing nodes, each of which is a computing node as described in the second aspect of the present application.

In this embodiment, a computing system including a plurality of computing nodes is expanded from the single computing node described in the above embodiments. This computing system includes at least three computing nodes, which are interconnected via the downlink scale-out expansion interfaces reserved on the switch expansion boards and the fifth communication links, forming a scalable computing system that can be conveniently expanded or contracted to match the parameter scale requirements of the training model, thereby meeting the training needs of large models with different parameter scales.

In some embodiments, for each computing node among the at least three computing nodes, the horizontal expansion interfaces of the two switch chips on the switch expansion board included in the computing are each connected to the horizontal expansion interfaces of the switch chips on the switch expansion boards included in two different computing nodes among the at least three computing nodes via a fifth communication link.

As shown in FIG. 4, this embodiment uses a computing system with three computing nodes as an example. In this computing system, the switch expansion board in each computing node is connected to the switch expansion boards in another two different computing nodes via the reserved scale-out expansion interfaces and the fifth communication links. The first PCIe switch chip on the switch expansion board of the first computing node is connected to the second PCIe switch chip on the switch expansion board of the third computing node; the second PCIe switch chip on the switch expansion board of the first computing node is connected to the first PCIe switch chip on the switch expansion board of the second computing node; the second PCIe switch chip on the switch expansion board of the second computing node is connected to the first PCIe switch chip on the switch expansion board of the third computing node.

It should be noted that in a computing system with a plurality of computing nodes, when expanding computing nodes through the downlink scale-out expansion interfaces reserved on the PCIe switch chips of the switch expansion boards, the connection sequence of the PCIe switch chips is not limited as long as the two PCIe switch chips on the switch expansion board of one computing node are connected to the PCIe switch chips in two different computing nodes. In this way, a multi-node architecture of the computing system can be achieved.

In the computing system with a plurality of computing nodes, all accelerator cards in all computing nodes are fully interconnected, enabling the computing system to achieve optimal computational performance at the current node scale.

According to the computing system provided in this application, an elastically scalable computing system architecture is formed through modular baseboard design and interconnection. This enables the computing system to match model training tasks of varying parameter scales, ensuring that the system's computational power and bandwidth align with the training requirements of models with different parameter scales. The computing system offered by this application is not only convenient for expansion but also highly efficient in operation, making it particularly suitable for the training needs of large AI models with massive parameter scales.

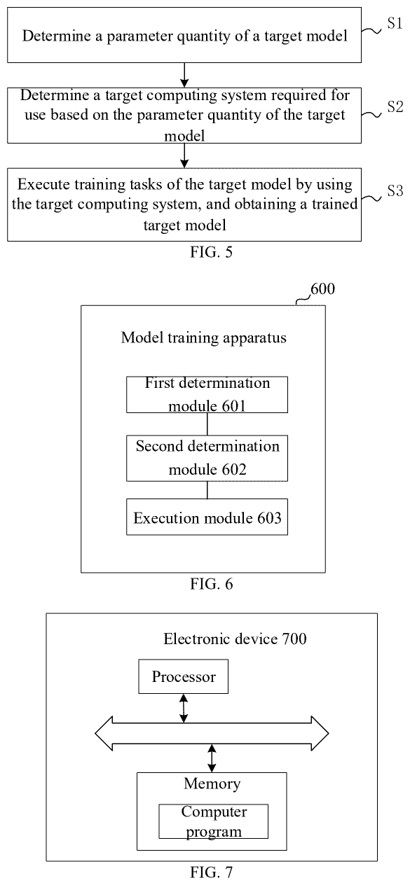

Based on the same creative concept, an embodiment of the present application provides a model training method. Referring to FIG. 5, FIG. 5 is a flowchart of a model training method provided in an embodiment of the present application. As shown in FIG. 5, the model training method includes steps described below.

At S1, a parameter quantity of a target model is determined.

At S2, a target computing system required for use is determined based on the parameter quantity of the target model.

At S3, the target computing system is used to execute training tasks of the target model and obtain a trained target model.

In this embodiment, large models are trained using the computing system described in the above embodiment. First, the training parameter quantity of the target model is determined, and the architecture of the computing system is selected based on the parameter quantity. For example, when the parameter scale of the target model is small, the computing unit described in the above embodiment can be used for training the model, saving device resources while matching the computational power and bandwidth of the model. When the parameter quantity of the target model is very large, an expanded architecture with multiple computing nodes can be built according to the parameter scale of the model, ensuring that the computational power and bandwidth of the computing system match the model to be trained.

In some embodiments, the step, in which the parameter quantity of the target model is determined, includes:
S11, determining the parameter quantity of at least one model to be trained, where the at least one model to be trained is a model supporting parallel computations, and the at least one model to be trained includes the Transformer model.

In the model training method of this embodiment, the computing system described in the above embodiments is used to train models, especially large models supporting parallel computations. A computing system with a corresponding architecture is selected based on the parameter quantity scale of the model to be trained, and the training tasks of the model to be trained are split, enabling distributed parallel computations of the data operation during model training across multiple accelerator cards, thereby improving the training efficiency of the model.

Transformer is a deep learning model widely used in natural language processing, such as machine translation, text classification, and question-answering systems. The Transformer model is a classic NLP (Natural Language Processing) model proposed by Google. The currently popular BERT (Bidirectional Encoder Representation from Transformers) model is also based on the Transformer model. The advantage of the BERT model lies in maintaining good performance when processing long texts and enabling parallel computations to improve training speed. The Transformer model uses a self-attention mechanism rather than the sequential structure of RNN (Recurrent Neural Network), allowing the model to be trained in parallel and possess global information.

In this embodiment, for large AI models supporting parallel computations, such as the Transformer model and other models based on the Transformer model, this method can be used for model training. The computing system with a corresponding architecture is matched based on the parameter quantity scale of the model to be trained, improving the efficiency of model training.

In some embodiments, the step, in which the target computing system required for use is determined based on the parameter quantity of the target model, includes:
S21, determining a target interval in which the parameter quantity of the target model is located from multiple intervals;
S22, in response to determining that the target interval is a first interval, determining that the target computing system required for use is the computing unit as described in the first aspect of the present application;
S23, in response to determining that the target interval is a second interval, determining that the target computing system required for use is the computing node as described in the second aspect of the present application, where an upper limit of the first interval is less than a lower limit of the second interval;
S24, in response to determining that the target interval is a third interval, determining that the target computing system required for use is the computing system as described in the third aspect of the present application, where an upper limit of the second interval is less than a lower limit of the third interval;
S25, in response to determining that the target interval is a fourth interval, determining that the target computing system required for use is the computing system as described in the fourth aspect of the present application, where an upper limit of the third interval is less than a lower limit of the fourth interval.

In this embodiment, the architecture of the computing system to be used is determined based on the parameter scale of the model. Specifically, the architecture of the computing system corresponds to four intervals of parameter scale. When the parameter scale of the model falls within the first interval, the computing unit is used as the computing system architecture for training the model. When the parameter scale of the model falls within the second interval, a single computing node is used as the computing system architecture for training the model. When the parameter scale of the model falls within the third interval, an interconnected architecture with two computing nodes is used as the computing system architecture for training the model. When the parameter scale of the model falls within the fourth interval, an interconnected architecture with multiple computing nodes is used as the computing system architecture for training the model. In practical applications, the intervals of model parameter scales can be divided according to actual conditions to enable efficient model training using a matched computing system architecture.

In one embodiment, for example, a computing system architecture consisting of only one computing unit can be used to train models with parameters in the range of billions or smaller. A computing system architecture consisting of at least one computing node can be scaled according to the parameter quantity of the model to match the parameter quantity, enabling it to handle parameter quantity ranging from millions to trillions.

Based on the same creative concept, an embodiment of the present application provides a model training apparatus. FIG. 6 is a schematic diagram of a model training apparatus 600 provided in an embodiment of the present application. As shown in FIG. 6, the model training apparatus 600 includes:
a first determination module 601, configured to determine a parameter quantity of a target model;
a second determination module 602, configured to determine a target computing system required for use based on the parameter quantity of the target model; and
an execution module 603, configured to use the target computing system to execute training tasks of the target model and obtain a trained target model.

In some embodiments, the first determination module 601 is configured to determine the parameter quantity of at least one model to be trained, where the at least one model to be trained is a model supporting parallel computations, and the at least one model to be trained includes the Transformer model.

In some embodiments, the second determination module 602 is configured to perform the following steps:
determining a target interval in which the parameter quantity of the target model is located from multiple intervals;
in response to determining that the target interval is a first interval, determining that the target computing system required for use is the computing unit as described in the first aspect of the present application;
in response to determining that the target interval is a second interval, determining that the target computing system required for use is the computing node as described in the second aspect of the present application, where the upper limit of the first interval is less than the lower limit of the second interval;
in response to determining that the target interval is a third interval, determining that the target computing system required for use is the computing system as described in the third aspect of the present application, where the upper limit of the second interval is less than the lower limit of the third interval;
in response to determining that the target interval is a fourth interval, determining that the target computing system required for use is the computing system as described in the fourth aspect of the present application, where the upper limit of the third interval is less than the lower limit of the fourth interval.

In a seventh aspect, some embodiments of the present application provide a non-volatile computer readable storage medium. The non-volatile readable storage medium stores a computer program, and when the computer program is executed by a processor, the steps in the method described in the fifth aspect of the present application are implemented.

Based on the same creative concept, an embodiment of the present application provides an electronic device. FIG. 7 is a schematic diagram of an electronic device 700 provided in an embodiment of the present application. As shown in FIG. 7, the electronic device 700 includes a memory, a processor, and a computer program stored on the memory and executable on the processor. When the computer program is executed by the processor, the steps in the method described in the fifth aspect of the present application are implemented.

Regarding the apparatus in the above embodiments, the specific operations performed by each module have been described in detail in the embodiments related to the method and will not be elaborated here.

The above are only preferred embodiments of the present application and are not intended to limit the present application. Any modifications, equivalent replacements, or improvements made within the spirit and principles of the present application shall be included within the protection scope of the present application.

For the method embodiments, for simplicity, they are described as a series of action combinations. However, those skilled in the art should understand that the present application is not limited by the described action sequence, as certain steps may be performed in other sequences or simultaneously according to the present application. Additionally, those skilled in the art should understand that the embodiments described in the specification belong to the embodiments of the present application, and the actions and components involved are not necessarily required by the present application.

Those skilled in the art should understand that the embodiments of the present application can be provided as methods, apparatuses, or computer program products. Therefore, the embodiments of the present application can take the form of complete hardware embodiments, complete software embodiments, or embodiments combining software and hardware. Moreover, the embodiments of the present application can take the form of a computer program product implemented on one or more computer-usable storage media (including but not limited to disk storage, CD-ROM, optical storage, etc.) containing computer-usable program code.

The embodiments of the present application are described with reference to flowcharts and/or block diagrams of methods, terminal devices (systems), and computer program products according to some embodiments of the present application. It should be understood that each process and/or block in the flowcharts and/or block diagrams, as well as the combination of processes and/or blocks in the flowcharts and/or block diagrams, can be implemented by computer program instructions. These computer program instructions can be provided to a general-purpose computer, special-purpose computer, embedded processor, or other programmable data processing terminal device to produce a machine, so that the instructions executed by the computer or other programmable data processing terminal device produce a device for implementing the functions specified in one or more processes in the flowchart and/or one or more blocks in the block diagram.

These computer program instructions can also be stored in a computer-readable memory that can guide a computer or other programmable data processing terminal device to operate in a specific manner, so that the instructions stored in the computer-readable memory produce a manufactured product including an instruction device, which implements the functions specified in one or more processes in the flowchart and/or one or more blocks in the block diagram.

These computer program instructions can also be loaded onto a computer or other programmable data processing terminal device, so that a series of operational steps are executed on the computer or other programmable terminal device to produce computer-implemented processing, thereby providing steps for implementing the functions specified in one or more processes in the flowchart and/or one or more blocks in the block diagram through the instructions executed on the computer or other programmable terminal device.

Although the embodiments of the present application have been described, those skilled in the art, once aware of the basic creative concept, can make additional changes and modifications to these embodiments. Therefore, the appended claims are intended to be interpreted as including the embodiments of the present application and all changes and modifications falling within the scope of the embodiments of the present application.

Finally, it should also be noted that in this document, relational terms such as “first” and “second” are only used to distinguish one entity or operation from another entity or operation, and do not necessarily require or imply any actual relationship or sequence between these entities or operations. Moreover, the terms “include,” “comprise,” or any other variations thereof are intended to cover non-exclusive inclusion, so that a process, method, article, or terminal device that includes a series of elements includes not only those elements but also other elements not explicitly listed, or elements inherent to the process, method, article, or terminal device. Without further limitation, an element defined by the phrase “including a . . . ” does not exclude the presence of additional identical elements in the process, method, article, or terminal device that includes the element.

The above provides a detailed introduction to the computing system, model training method, apparatus, and product provided by the present application. Specific examples are used to explain the principles and implementation of the present application, and the descriptions of the above embodiments are only intended to help understand the method and core ideas of the present application. At the same time, for those skilled in the art, based on the ideas of the present application, there will be changes in specific implementations and application scopes. In summary, the content of this specification should not be construed as limiting the present application.

1. A computing unit, comprising:
a mainboard equipped with a Central Processing Unit (CPU);
a baseboard connected to the mainboard via a first communication link, wherein the baseboard is equipped with a plurality of accelerator cards that are connected via a second communication link;
wherein the mainboard is configured to split a training task of a target model into a plurality of parallel model training tasks, distribute the plurality of parallel model training tasks to the plurality of accelerator cards, and process training results from the plurality of accelerator cards to obtain a trained target model;
the plurality of accelerator cards are configured to execute their respective model training tasks in parallel and generate the training results.

2. The computing unit according to claim 1, wherein every two accelerator cards among the plurality of accelerator cards are connected via one second communication link.

3. The computing unit according to claim 1, wherein the mainboard and the baseboard are connected via two first communication link, one of the two first communication links is served as a downlink data transmission channel, and the other one is served as an uplink data transmission channel; or
one of the two first communication links is served as a primary data transmission channel, and the other one is served as a backup data transmission channel.

4. The computing unit according to 1, wherein a ratio of a number of the CPU to a number of the plurality of accelerator cards is 1:4.

5. A computing node, comprising:
a first computing unit and a second computing unit, wherein both the first computing unit and the second computing unit are the computing unit according to claim 1.

6. The computing node according to claim 5, wherein the CPU on the mainboard of the first computing unit is connected to the CPU on the mainboard of the second computing unit via a third communication link.

7. The computing node according to claim 5, further comprising:
a switch expansion board configured to connect the first computing unit with the second computing unit.

8. The computing node according to claim 7, wherein the switch expansion board is equipped with two switch chips;
the accelerator cards in the first computing unit and the second computing unit are each connected to each of the two switch chips via a fourth communication link.

9. The computing node according to claim 8, wherein each of the switch chips on the switch expansion board is equipped with a horizontal expansion interface, and the horizontal expansion interface is configured to be connected to switch chips on switch expansion boards in other computing nodes.

10. The computing node according to claim wherein each of the switch chips is a PCIe chip, and the fourth communication link is a PCIe communication link.

11. A computing system, comprising:
a first computing node and a second computing node, wherein both the first computing node and the second computing node are the computing node according to claim 9.

12. The computing system according to claim 11, wherein the horizontal expansion interface of the first switch chip on the switch expansion board of the first computing node is connected to the horizontal expansion interface of the second switch chip on the switch expansion board of the second computing node via one fifth communication link; and
the horizontal expansion interface of the second switch chip on the switch expansion board of the first computing node is connected to the horizontal expansion interface of the first switch chip on the switch expansion board of the second computing node via one fifth communication link.

13. A computing system, comprising:
at least three computing nodes, wherein each of the computing nodes is the computing node according to claim 9.

14. The computing system according to claim 13, wherein, for each computing node among the at least three computing nodes, the horizontal expansion interfaces of the two switch chips on the switch expansion board in the computing node are each connected to the horizontal expansion interfaces of the switch chips on the switch expansion boards in two different computing nodes among the at least three computing nodes via one fifth communication link.

15. A model training method, comprising:
determining a parameter quantity of a target model;
determining a target computing system required for use based on the parameter quantity of the target model; and
executing training tasks of the target model by using the target computing system, and obtaining a trained target model.

16. The model training method according to claim 15, wherein the determining a target computing system required for use based on the parameter quantity of the target model comprises:
determining a target interval in which the parameter quantity of the target model is located from multiple intervals;
in response to determining that the target interval is a first interval, determining that the target computing system required for use is the computing unit according to claim 1;
in response to determining that the target interval is a second interval, determining that the target computing system required for use is a computing node with two computing units according to claim 1, wherein an upper limit of the first interval is less than a lower limit of the second interval;
in response to determining that the target interval is a third interval, determining that the target computing system required for use is a computing system with two computing nodes, wherein an upper limit of the second interval is less than a lower limit of the third interval;
in response to determining that the target interval is a fourth interval, determining that the target computing system required for use is a computing system with at least three computing nodes, wherein an upper limit of the third interval is less than a lower limit of the fourth interval.

17. The model training method according to claim 15, wherein the determining a parameter quantity of a target model comprises:
determining the parameter quantity of at least one model to be trained, wherein the at least one model to be trained is a model supporting parallel computation, and the at least one model to be trained comprises a Transformer model.

18. (canceled)

19. A non-transitory computer readable storage medium storing with a computer program that, when executed by a processor, causes the processor to implement steps in the model training method according to claim 15.

20. An electronic device, comprising a memory, a processor, and a computer program stored on the memory and executable on the processor, wherein, when the processor executes the computer program, steps in the model training method according to claim 15 are implemented.

21. The electronic device according to claim 20, wherein the processor is configured to perform operations of:
determining a target interval in which the parameter quantity of the target model is located from multiple intervals;
in response to determining that the target interval is a first interval, determining that the target computing system required for use is the computing unit according to claim 1;
in response to determining that the target interval is a second interval, determining that the target computing system required for use is a computing node with two computing units according to claim 1, wherein an upper limit of the first interval is less than a lower limit of the second interval;
in response to determining that the target interval is a third interval, determining that the target computing system required for use is a computing system with two computing nodes, wherein an upper limit of the second interval is less than a lower limit of the third interval;
in response to determining that the target interval is a fourth interval, determining that the target computing system required for use is a computing system with at least three computing nodes, wherein an upper limit of the third interval is less than a lower limit of the fourth interval.
